(19) United States
(12) Patent Application Publication
(10) Pub. No.: US 2013/0223419 A1
(43) Pub. Date: Aug. 29, 2013

(54) METHOD, APPARATUS, AND COMPUTER PROGRAM PRODUCT FOR POWER SAVING ENHANCEMENTS IN WIRELESS COMMUNICATION

(71) Applicants: Chittabrata GHOSH, Union City, VA (US); Klaus Doppler, Albany, CA (US); Zhong-Yi Jin, Albany, CA (US); Taejoon Kim, Berkeley, CA (US)

(72) Inventors: Chittabrata GHOSH, Union City, VA (US); Klaus Doppler, Albany, CA (US); Zhong-Yi Jin, Albany, CA (US); Taejoon Kim, Berkeley, CA (US)

(73) Assignee: Nokia Corporation, Espoo (FI)

(21) Appl. No.: 13/408,523

(22) Filed: Feb. 29, 2012

(51) Int. Cl. H04W 52/02; H04W 84/02

(52) U.S. Cl. 370/338

(57) ABSTRACT

Method, apparatus, and computer program product embodiments enable power saving in network environments. An example embodiment comprises: transmitting by a first wireless device to a second wireless device, a first message indicating an awake state with availability to receive wireless messages from the second wireless device, the first message including a threshold value for acceptance by the first device of buffered data in the second device; and receiving by the first wireless device, an immediate acknowledgement message from the second wireless device, if the buffered data in the second device satisfies the threshold value or receiving by the first wireless device, a delayed acknowledgement message from the second wireless device, if the buffered data in the second device does not satisfy the threshold value.

### FIELD

The field of technology relates to wireless communication and more particularly to power saving in network environments.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for power saving in network environments.

An example embodiment of the invention includes a method comprising:

transmitting by a first device to a second device, a first message indicating an awake state with availability to receive wireless messages from the second device, the first message including a threshold value for acceptance by the first device of buffered data in the second device; and

receiving by the first device, an immediate acknowledgement message from the second device, if the buffered data in the second device satisfies the threshold value, or receiving by the first device, a delayed acknowledgement message from the second device, if the buffered data in the second device does not satisfy the threshold value.

An example embodiment of the invention includes the method further comprising:

entering a sleep state by the first device when an immediate acknowledgement message is not received from the second device in response to the first message; and

waiting for a predetermined duration before resuming an awake state to receive the delayed acknowledgement message from the second device.

An example embodiment of the invention includes the method further comprising:

receiving by the first device, a priority frame message from the second device, including a priority indication for the first device, based on the threshold value for acceptance by the first device of buffered data in the second device; and

entering a sleep state for a predetermined duration before resuming the awake state to receive the delayed acknowledgement message.

An example embodiment of the invention includes the method further comprising:

wherein the delayed acknowledgement message includes a buffered units indication indicating whether there is data buffered in the second device for the first device and a duration field to a next service period, indicating a duration to initiation of a downlink data phase from the second device to the first device; and

entering a sleep state until the duration to the next service period in order to receive the buffered data if the buffered data units indication indicates that there is buffered data or entering a sleep state for a predetermined duration if the buffered data units indication indicates that there is no buffered data.

An example embodiment of the invention includes the method further comprising:

wherein the threshold value is at least one of a critical data value indicating whether the first wireless device is waiting for time-critical data, a buffered data quantity threshold value, and a quality of service threshold value for the buffered data.

An example embodiment of the invention includes an apparatus comprising:

at least one processor;

at least one memory including computer program code;

the at least one memory and the computer program code configured to, with the at least one processor, cause the apparatus at least to:

transmit to a second device, a first message indicating an awake state with availability to receive wireless messages from the second device, the first message including a threshold value for acceptance by the apparatus of buffered data in the second device; and

receive an immediate acknowledgement message from the second device, if the buffered data in the second device satisfies the threshold value, or receive a delayed acknowledgement message from the second device, if the buffered data in the second device does not satisfy the threshold value.

An example embodiment of the invention includes the apparatus further comprising:

the at least one memory and the computer program code configured to, with the at least one processor, cause the apparatus at least to:

enter a sleep state when an immediate acknowledgement message is not received from the second device in response to the first message; and

wait for a predetermined duration before resuming an awake state to receive the delayed acknowledgement message from the second device.

An example embodiment of the invention includes the apparatus further comprising:

the at least one memory and the computer program code configured to, with the at least one processor, cause the apparatus at least to:

receive a priority frame message from the second device, including a priority indication for the apparatus, based on the threshold value for acceptance by the apparatus of buffered data in the second device; and

enter a sleep state for a predetermined duration before resuming the awake state to receive the delayed acknowledgement message.

An example embodiment of the invention includes the apparatus further comprising:

wherein the delayed acknowledgement message includes a buffered units indication indicating whether there is data buffered in the second device for the apparatus and a duration field to a next service period, indicating a duration to initiation of a downlink data phase from the second device to the first device; and

the at least one memory and the computer program code configured to, with the at least one processor, cause the apparatus at least to:

enter a sleep state until the duration to the next service period in order to receive the buffered data if the buffered data units indication indicates that there is buffered data or entering a sleep state for a predetermined duration if the buffered data units indication indicates that there is no buffered data.

An example embodiment of the invention includes the apparatus further comprising:

wherein the threshold value is at least one of a critical data value indicating whether the first device is waiting for time-critical data, a buffered data quantity threshold value, and a quality of service threshold value for the buffered data.

An example embodiment of the invention includes a computer program product comprising computer executable program code recorded on a computer readable, non-transitory storage medium, the computer executable program code comprising:

code for transmitting to a second device, a first message indicating an awake state with availability to receive wireless messages from the second device, the first message including a threshold value for acceptance of buffered data in the second device; and

code for receiving an immediate acknowledgement message from the second device, if the buffered data in the second device satisfies the threshold value, or receiving a delayed acknowledgement message from the second device, if the buffered data in the second device does not satisfy the threshold value.

An example embodiment of the invention includes a method comprising:

receiving by an apparatus from a first device, a first message indicating an awake state with availability to receive wireless messages from the apparatus, the first message including a threshold value for acceptance by the first device of buffered data in the apparatus; and

transmitting by the apparatus to the first device, an immediate acknowledgement message, if the buffered data in the apparatus satisfies the threshold value, or transmitting by the apparatus to the first device, a delayed acknowledgement message, if the buffered data in the apparatus does not satisfy the threshold value.

An example embodiment of the invention includes the method further comprising:

setting by the apparatus, a buffered units indication in the immediate acknowledgement message, indicating whether there is data buffered in the apparatus for the first device.

An example embodiment of the invention includes the method further comprising:

transmitting by the apparatus to the first device, a priority frame message, including a priority indication for the first device, based on the threshold value for acceptance by the first device of buffered data in the apparatus.

An example embodiment of the invention includes the method further comprising:

setting by the apparatus, a buffered units indication in the delayed acknowledgement message, indicating whether there is data buffered in the apparatus for the first device.

An example embodiment of the invention includes the method further comprising:

wherein the threshold value is at least one of a critical data value indicating whether the first device is waiting for time-critical data, a buffered data quantity threshold value, and a quality of service threshold value for the buffered data.

An example embodiment of the invention includes an apparatus comprising:

at least one processor;

at least one memory including computer program code;

the at least one memory and the computer program code configured to, with the at least one processor, cause the apparatus at least to:

receive from a first device, a first message indicating an awake state with availability to receive wireless messages from the apparatus, the first message including a threshold value for acceptance by the first device of buffered data in the apparatus; and

transmit by the apparatus to the first device, an immediate acknowledgement message, if the buffered data in the apparatus satisfies the threshold value or transmit by the apparatus to the first device, a delayed acknowledgement message, if the buffered data in the apparatus does not satisfy the threshold value.

An example embodiment of the invention includes the apparatus further comprising:

the at least one memory and the computer program code configured to, with the at least one processor, cause the apparatus at least to:

set in the immediate acknowledgement message a buffered units indication, which is based on the device type, wake-up period, and buffered data threshold indication from the first device; the buffered units indication informing whether there is data buffered in the apparatus for the first device, wherein the first device is of highest priority,

An example embodiment of the invention includes the apparatus further comprising:

the at least one memory and the computer program code configured to, with the at least one processor, cause the apparatus at least to:

transmit to the first device, a priority frame message, including a priority indication for the first device, based on the threshold value for acceptance by the first device of buffered data in the apparatus.

An example embodiment of the invention includes the apparatus further comprising:

set a buffered units indication in the delayed acknowledgement message, indicating whether there is data buffered in the apparatus for the first device and a duration field to a next service period, indicating a duration to initiation of a downlink data phase from the apparatus to the first device.

An example embodiment of the invention includes the apparatus further comprising:

wherein the threshold value is at least one of a critical data value indicating whether the first device is waiting for time-critical data, a buffered data quantity threshold value, and a quality of service threshold value for the buffered data.

An example embodiment of the invention includes a computer program product comprising computer executable program code recorded on a computer readable, non-transitory storage medium, the computer executable program code comprising:

code for receiving by an apparatus from a first device, a first message indicating an awake state with availability to receive wireless messages from the apparatus, the first message including a threshold value for acceptance by the first device of buffered data in the apparatus; and

code for transmitting by the apparatus to the first device, an immediate acknowledgement message, if the buffered data in the apparatus satisfies the threshold value, or transmitting by the apparatus to the first device, a delayed acknowledgement message, if the buffered data in the apparatus does not satisfy the threshold value.

The resulting embodiments for power saving in network environments.

### DESCRIPTION OF THE FIGURES

FIG. 1 is an example network diagram of a wireless network including highest priority WLAN client devices, medium priority WLAN client devices, and least priority WLAN client devices, and a WLAN access point device, wherein the client devices share their respective device types and wake-up periods with the access point during association and authentication phases using Association Request and Association Response frames, establishing WLAN links in a wireless infrastructure BSS, according to an example embodiment of the invention.

FIG. 1A is an example network diagram of the wireless network of FIG. 1, with a WLAN client device sending a power save poll packet, which includes the buffered data threshold and critical data values, to the WLAN access point device, according to an example embodiment of the invention.

FIG. 1B shows the example network diagram of FIG. 1A, wherein the WLAN access point device transmits an immediate acknowledgement packet to the WLAN client device of highest priority, with a buffer unit value indicating buffered data is present in the WLAN access point device, according to an example embodiment of the invention.

FIG. 1C shows the example network diagram of FIG. 1A, wherein WLAN access point transmits a priority frame to WLAN client devices in the network, specifying the identifications and priorities of the respective WLAN client devices, according to an example embodiment of the invention.

FIG. 1D shows the example network diagram of FIG. 1A, wherein WLAN access point transmits a medium priority block acknowledgement frame to medium priority WLAN client devices in the network, according to an example embodiment of the invention.

FIG. 1E shows the example network diagram of FIG. 1A, wherein WLAN access point transmits a least priority block acknowledgement frame to least priority WLAN client devices in the network, according to an example embodiment of the invention.

FIG. 2A is an example functional block diagram, illustrating an example WLAN client device, according to an example embodiment of the invention.

FIG. 2B is an example flow diagram of operational steps in the WLAN client device of FIG. 2A, according to an example embodiment of the invention.

FIG. 3A is an example functional block diagram, illustrating an example WLAN access point device, according to an example embodiment of the invention.

FIG. 3B is an example flow diagram of operational steps in the WLAN access point device of FIG. 3A, including control information indicating a duration until a service period starts.

FIG. 4 is an example frame structure of the association request packet, according to an example embodiment of the invention.

FIG. 4A is an example frame structure of the power save poll packet, according to an example embodiment of the invention.

FIG. 4B is an example frame structure of the immediate acknowledgement packet, according to an example embodiment of the invention.

FIG. 4C is an example frame structure of the priority frame packet, according to an example embodiment of the invention.

FIG. 4D is an example frame structure of the medium priority block acknowledgement frame packet, according to an example embodiment of the invention.

FIG. 4E is an example frame structure of the least priority block acknowledgement frame packet, according to an example embodiment of the invention.

FIG. 5 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

### DISCUSSION OF EXAMPLE EMBODIMENTS OF THE INVENTION

This section is organized into the following topics:

A. WLAN Communication Technology

B. Power Saving Enhancements in Wireless Communication

A. WLAN Communication Technology

The IEEE 802.11 standard specifies methods and techniques of an exemplary wireless local area network (WLAN) operation. examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007 (incorporated herein by reference). Since then, emerging broadband applications have stimulated interest in developing very high-speed wireless networks for short range communication, for example, the IEEE 802.11n, the planned IEEE 802.11 ac, and the planned IEEE 802.11ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11 ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

In a block acknowledgement (BA), instead of transmitting an individual ACK for every MAC protocol data unit (MPDU), multiple MPDUs may be acknowledged together using a single BA frame. Block Ack (BA) contains bitmap size of 64*16 bits. Each bit of this bitmap represents the success or failure status of a MPDU.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the mobile device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TBTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the mobile device. There may be no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame or power save poll packet to the AP when the STA wakes up, to retrieve any queued data at the AP and also transmit any data queued from the STA to the AP. In S-APSD, the AP assigns a schedule to a STA and the STA wakes up at the assigned time to retrieve from the AP any data queued for the STA. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

The IEEE 802.11 ah WLAN standard operating below 1 GHz, has a greater range and lower obstruction losses due to its longer wavelength. IEEE 802.11 ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

The Quality of Service (QoS) support in the IEEE 802.11 WLAN protocol is provided by access categories (ACs) and multiple independent backoff entities. The Quality of Service (QoS) support defines the MAC procedures to support local area network (LAN) applications with quality of service (QoS) requirements, including the transport of voice, audio, and video.

Packets are delivered by parallel backoff entities operating within the same WLAN device, where backoff entities are prioritized using AC-specific contention parameters. There are four access categories (ACs) and thus, four backoff entities exist in every WLAN device. The AC-specific contention parameters are labeled according to their target application: AC_VO for voice or audio packets, AC_VI for video packets, AC_BE for packets whose delivery is on a best effort basis, and AC_BK for background packets. The four access categories (ACs) define the priorities in accessing the medium by setting individual interframe spaces, contention windows, and other medium access parameters per access category (AC).

Contention-based medium access is performed in every backoff entity by using different parameter values for the AC-specific contention parameters. The AC-specific contention parameters are announced via information fields in beacon frames. The same AC-specific contention parameters are used by the backoff entities different WLAN devices in the network.

Each backoff entity within a WLAN device independently contends for a transmit opportunity (TXOP) of a packet. It starts down-counting the backoff-counter after detecting the medium being idle for a duration defined by the arbitration interframe space (AIFS) that is based on the value of the AC-specific contention parameter of the packet to be transmitted. The arbitration interframe space (AIFS) defines the earliest access time that the WLAN device may transmit the packet. Voice packets that have the AC-specific contention parameter AC_VO and video packets that have the AC-specific contention parameter AC_VI have a high value for access priority. Best effort basis packets that have the AC-specific contention parameter AC_BE have a medium value for access priority. Background packets that have the AC-specific contention parameter AC_BK have a low value for access priority.

The minimum size of the contention window, CWmin, for transmission of a packet, is another parameter dependent on the AC-specific contention parameter. The smaller the CWmin, the higher the priority of the packet for accessing the medium. Voice packets that have the AC-specific contention parameter AC_VO have the smallest contention window whereas background packets that have the AC-specific contention parameter AC_BK have the longest contention window.

B. Efficient Power Saving in Wireless Communication

In sensor networks and smart grid applications, large numbers of client wireless devices, both fixed and mobile, will need to communicate with an access point device. In such applications, the client devices operate on battery power and must conserve their power during long periods of inactivity punctuated by short duration communication sessions. In applications where there are a large number of client devices, there is a high likelihood that the wireless medium is loaded and the access point device may not always be able to immediately serve the traffic. When a client wireless device wakes up from a doze or sleep state and attempts to send a power save poll packet to the access point device, it may have to wait to complete its connection due to network overloading, its power will be wasted while it is waiting.

In accordance with an example embodiment of the invention, network overloading may be reduced by enabling the WLAN access point (AP) device to prioritize its communications with WLAN client devices based on utilizing additional information related to downlink buffered data expected by WLAN client devices in power save mode. The requirements for downlink data by the WLAN client devices may change (demanding immediate or gradual action) over a period of time. For example, requirements for downlink data vary for reconfiguration data, re-association data, channel switching information, and channel report status information, and other types of data. Hence, information characterizing the requirements for downlink data may be appended in a power save poll (PS-Poll) message or a trigger frame, in case of unsynchronized automatic power save delivery (APSD), sent by a WLAN client device to the WLAN access point (AP) device. Other types of messages from the WLAN client device may also be used for transmitting this information to the WLAN access point (AP) device. This added information may assist the WLAN access point (AP) device in prioritizing buffered data delivery among a plurality of WLAN client devices in its network.

In an example embodiment of the invention, a power save poll (PS-Poll) message, a trigger frame, or other type message sent by the WLAN client device to the AP, may include a threshold value for acceptance by the WLAN client device of buffered data in the WLAN access point (AP) device. The threshold value may include three additional fields: a Buffered Data Quantity Threshold field, a Critical Data field, and a Quality of Service (QoS) class field.

The WLAN client device may transmit to the WLAN access point (AP) device, a power save poll (PS-Poll) message indicating an awake state with availability to receive wireless messages from the WLAN access point (AP) device. The power save poll (PS-Poll) message may include the threshold value for acceptance by the WLAN client device of buffered data in the WLAN access point (AP) device.

The WLAN client device may receive an immediate acknowledgement message from the WLAN access point (AP) device, if the buffered data in the WLAN access point (AP) device satisfies the threshold value for acceptance. Alternately, the WLAN client device may receive a delayed acknowledgement message from the WLAN access point (AP) device, if the buffered data in the WLAN access point (AP) device does not satisfy the threshold value for acceptance. The threshold value may include three fields: a Buffered Data Quantity Threshold field, a Critical Data field, and a Quality of Service (QoS) class field.

Correspondingly, WLAN access point (AP) device may receive from the WLAN client device, the power save poll (PS-Poll) message indicating an awake state with availability to receive wireless messages from the WLAN access point (AP) device, the power save poll (PS-Poll) message including the threshold value for acceptance by the first device of buffered data in the WLAN access point (AP) device. The WLAN access point (AP) device may transmit to the WLAN client device, an immediate acknowledgement message, if the buffered data in the WLAN access point (AP) device satisfies the threshold value for acceptance.

Alternately, the WLAN access point (AP) device may transmit to the WLAN client device, a delayed acknowledgement message, if the buffered data in the WLAN access point (AP) device does not satisfy the threshold value for acceptance. The threshold value may include three fields: a Buffered Data Quantity Threshold field, a Critical Data field, and a Quality of Service (QoS) class field.

1. Buffered Data Quantity Threshold: This field indicates a threshold (in Kbytes expressed as an exponent of 2 to minimize the number of transmitted bits, for example, a value of 4 indicates a threshold of 16 KB) of buffered data, above which the WLAN client device wishes to receive notice of the buffered data. An ACK frame is sent by the WLAN access point (AP) device in response to the power save poll (PS-Poll) message, trigger frame, or other type message. The ACK frame may include a buffer units (BU) field indicating whether there is data buffered in the AP for the WLAN client device. If the number of bytes of buffered data in the AP exceeds the Buffered Data Quantity Threshold indicated in the power save poll (PS-Poll) message, for example, the AP will set the value of the buffer units field to BU=1 in the ACK frame indicating that there is buffered data present in the AP. If the number of bytes of buffered data in the AP is less than the Buffered Data Quantity Threshold indicated in the power save poll (PS-Poll) message, for example, the AP will set the value of the buffer units field to BU=0 in the ACK frame indicating that there is no buffered data present in the AP. Even if there is actually some data buffered in the AP for the WLAN client device, if it is less than the Buffered Data Quantity Threshold indicated in the power save poll (PS-Poll) message, then the AP will set the value of the buffer units field to BU=0 in the ACK frame. This field is utilized by the WLAN access point device in defining priorities among the WLAN client devices;

2. Critical Data: This 1-bit field indicates if a WLAN client device is waiting for time-critical or periodic information. This field is also utilized by the WLAN access point device in defining priorities among the WLAN client devices.

In an example embodiment of the invention, the Buffered Data Quantity Threshold and Critical Data are inter-related. If the WLAN client device is waiting for time-sensitive (for example, channel switching information) data, the WLAN client device may set the Buffered Data Quantity Threshold to a lower value (in Kbytes). This enables the WLAN client device to receive an even lower quantity of buffered data from the AP. In an example embodiment of the invention, the WLAN client device may set the Buffered Data Quantity Threshold close to the Maximum buffer size of the WLAN client device for non-critical data.

3. Quality of Service (QoS): The buffered data threshold may also include a quality of service class. If the data buffered in the WLAN access point 50 is of lower quality than the Quality of Service (QoS) class indicated by the WLAN client device 100 in the power save poll (PS-Poll) message 110, then the WLAN client device does not want to receive the buffered data. The WLAN client device 100 will receive an immediate acknowledgement message 120 from the WLAN access point device 50, if the buffered data 130 in the WLAN access point device satisfies the threshold value of the Quality of Service (QoS) class indicated by the WLAN client device in the power save poll (PS-Poll) message 110. Alternately, WLAN client device 100 will receive a delayed acknowledgement message 160 or 170 from the WLAN access point device 50, if the buffered data in the WLAN access point device 50 does not satisfy the threshold value of the Quality of Service (QoS) class indicated by the WLAN client device 100 in the power save poll (PS-Poll) message 110.

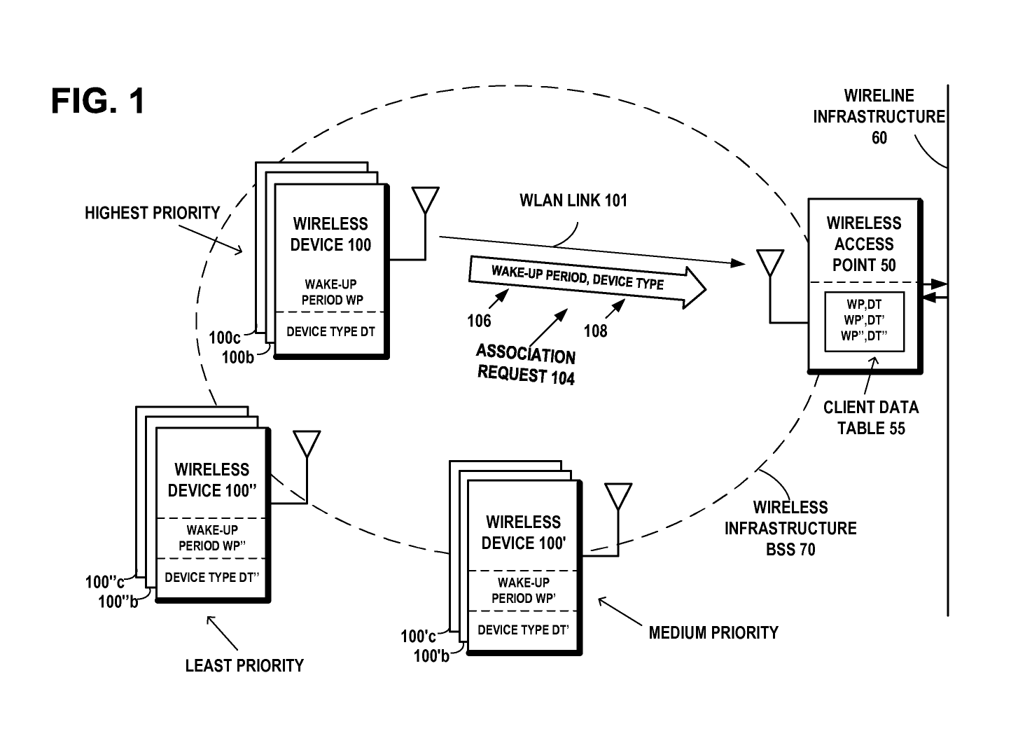

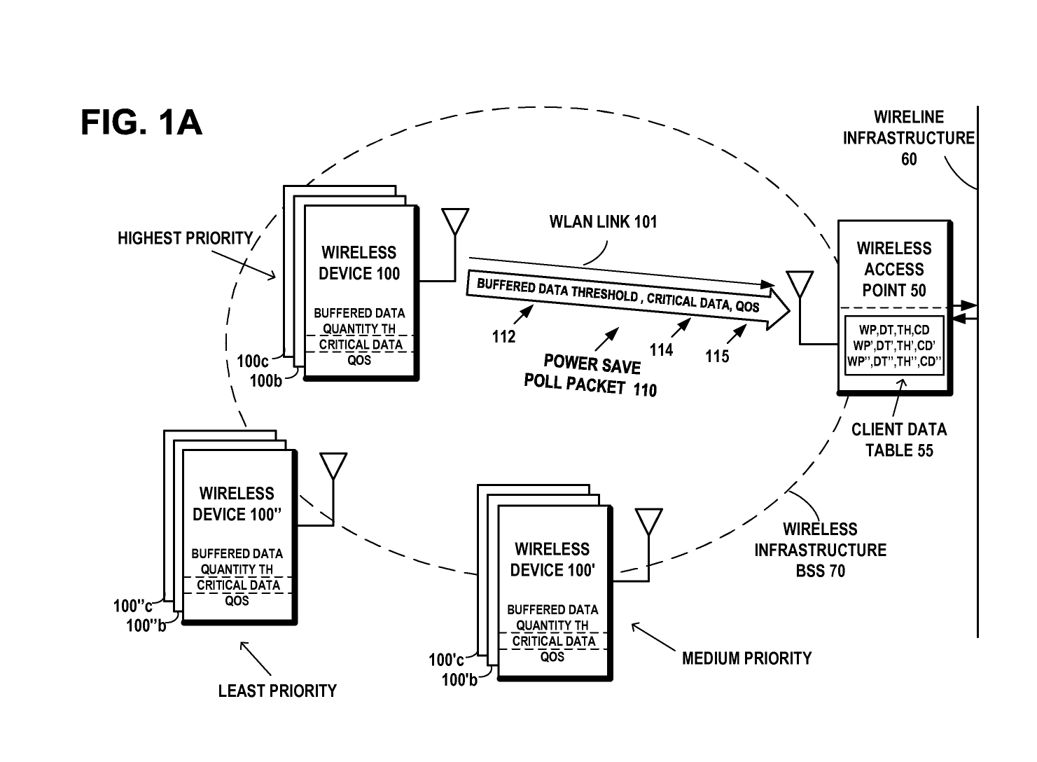

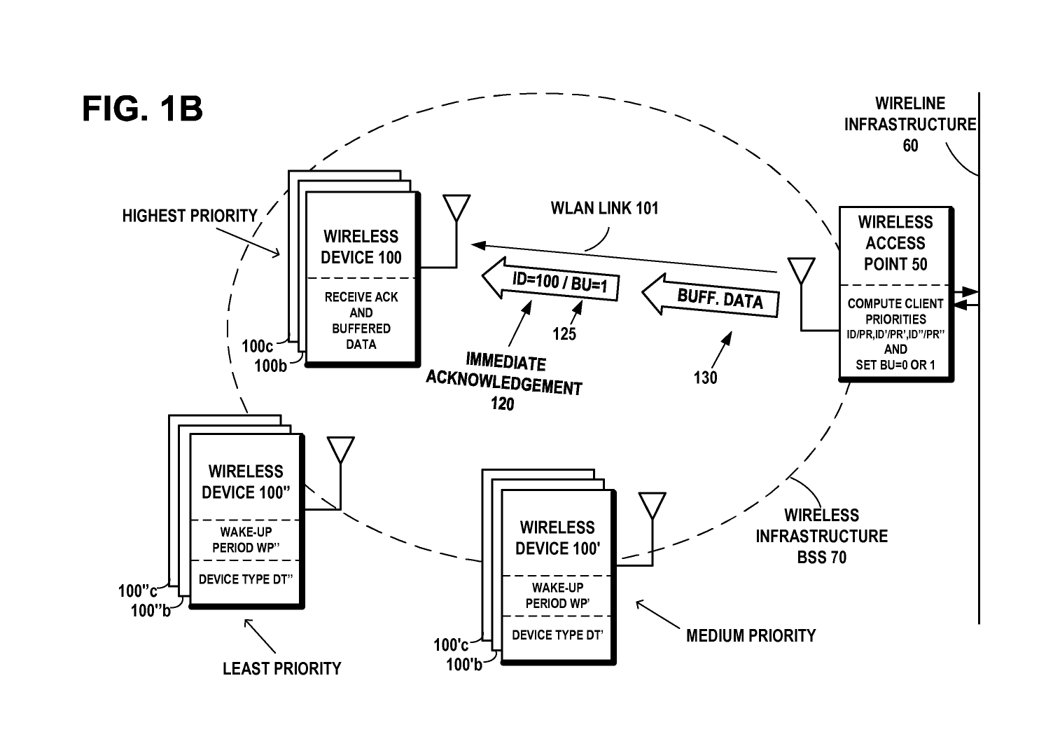

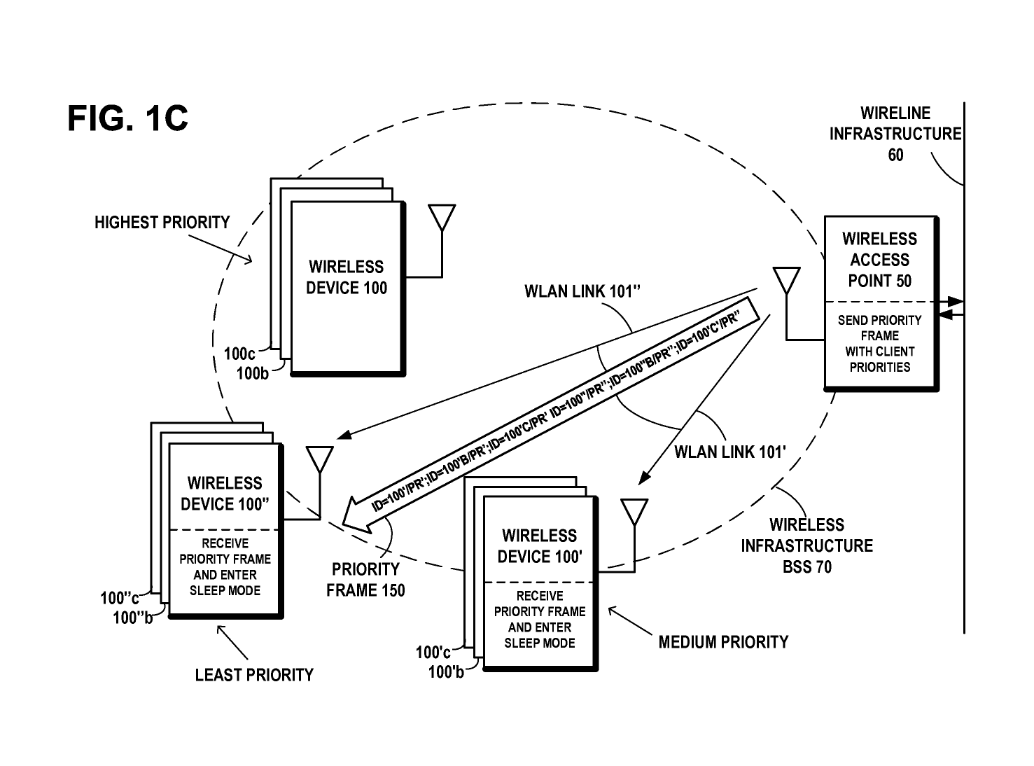

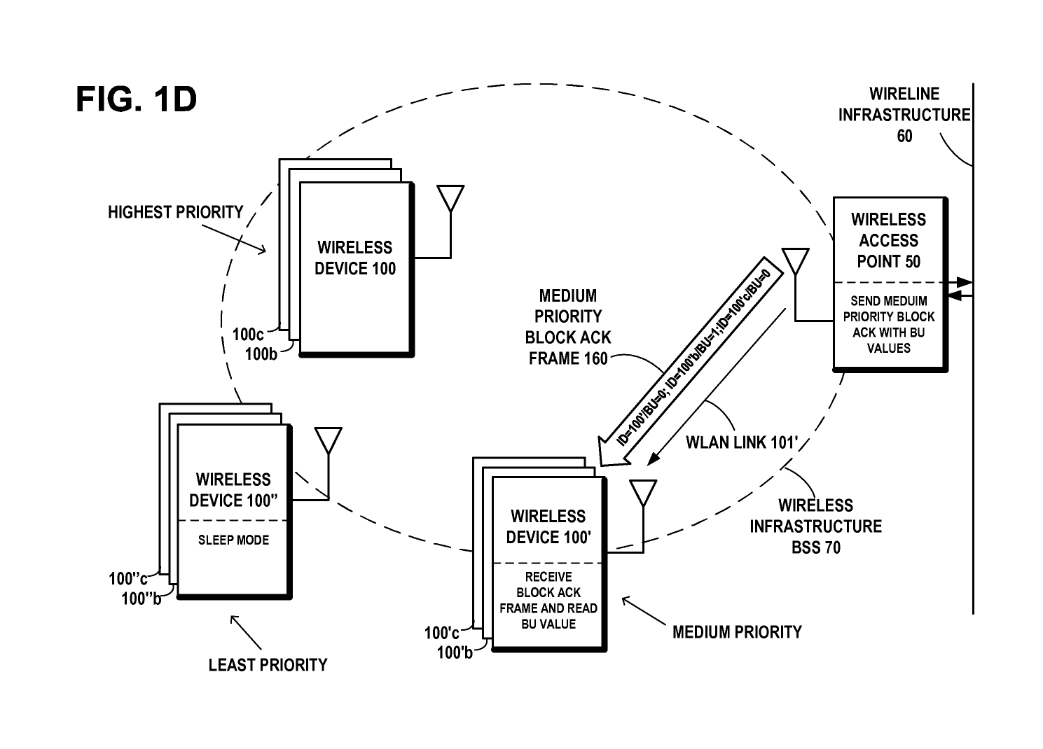

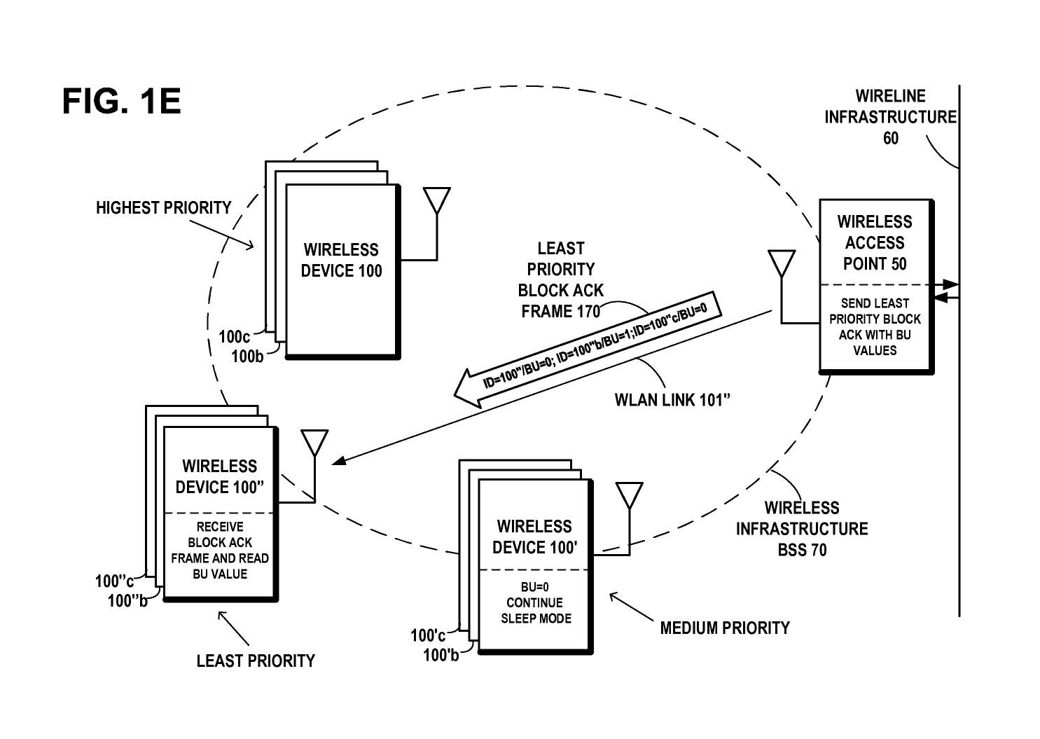

FIG. 1 is an example network diagram of a wireless network, with a WLAN client device 100 and WLAN access point device 50 during the association and authentication phase using Association Request frame 104 and Association Response frame to establish a WLAN link 101 in a wireless infrastructure network BSS 70, according to an example embodiment of the invention. In the example shown, the WLAN client device 100 is one of a plurality of client devices 100, 100b, and 100c that have the Highest priority with the Critical Data field set to 1 and quality of service field set above a certain threshold. A second WLAN client device 100′ is also shown in the wireless infrastructure network BSS 70. In the example shown, the second WLAN client device 100′ is one of a plurality of client devices 100′, 100′b, and 100′c that have a medium priority with the Critical Data field set to 0 and buffered data>Buffered Data Quantity Threshold but buffered data<Maximum buffer size per WLAN client device. A third WLAN client device 100″ is also shown in the wireless infrastructure network BSS 70. In the example shown, the third WLAN client device 100″ is one of a plurality of client devices 100″, 100″b, and 100″c that have a least priority with the Critical Data field set to 0 and buffered data<Buffered Data Threshold.

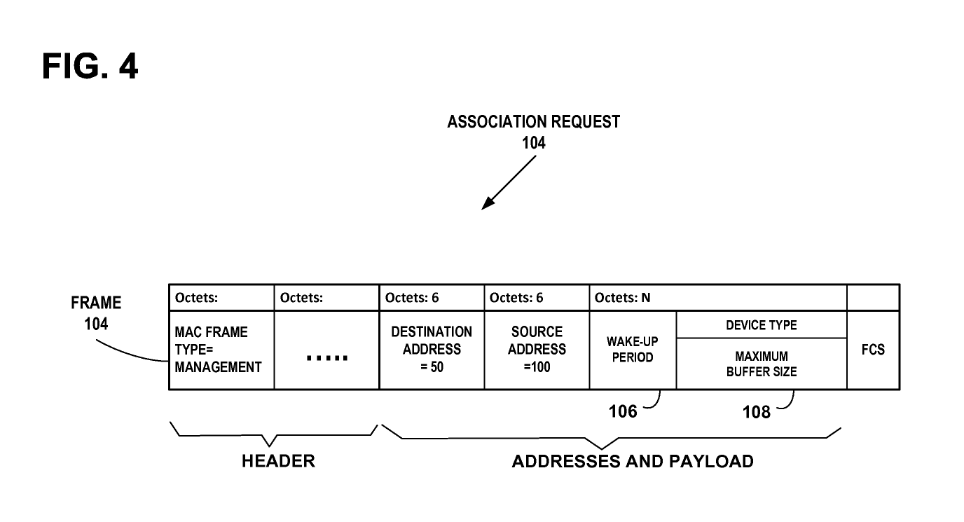

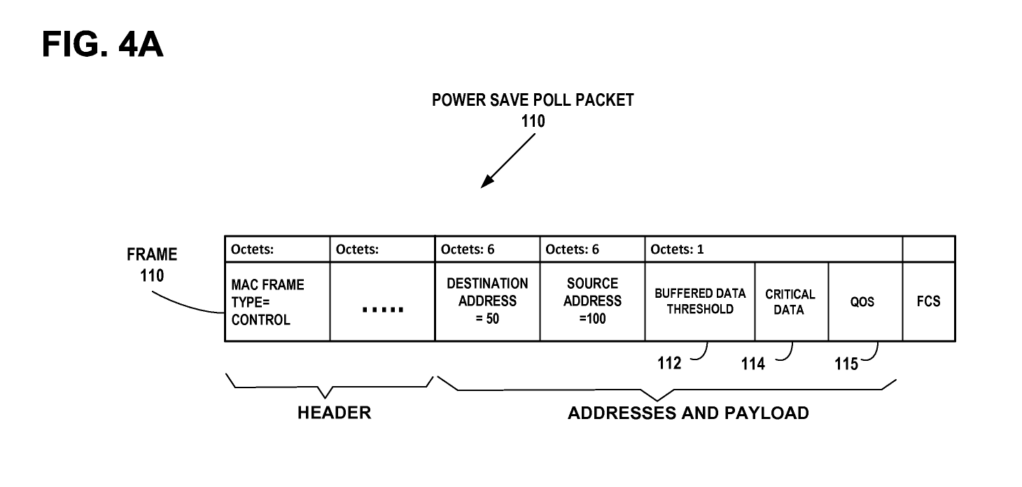

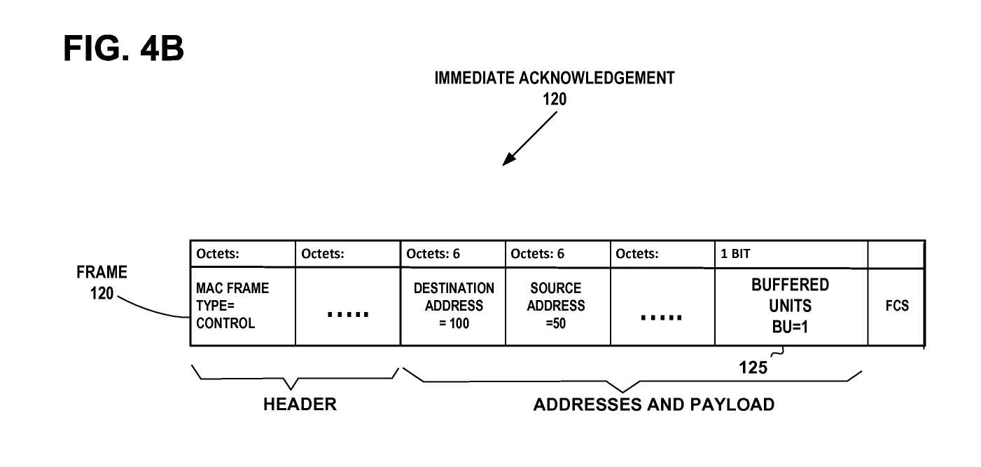

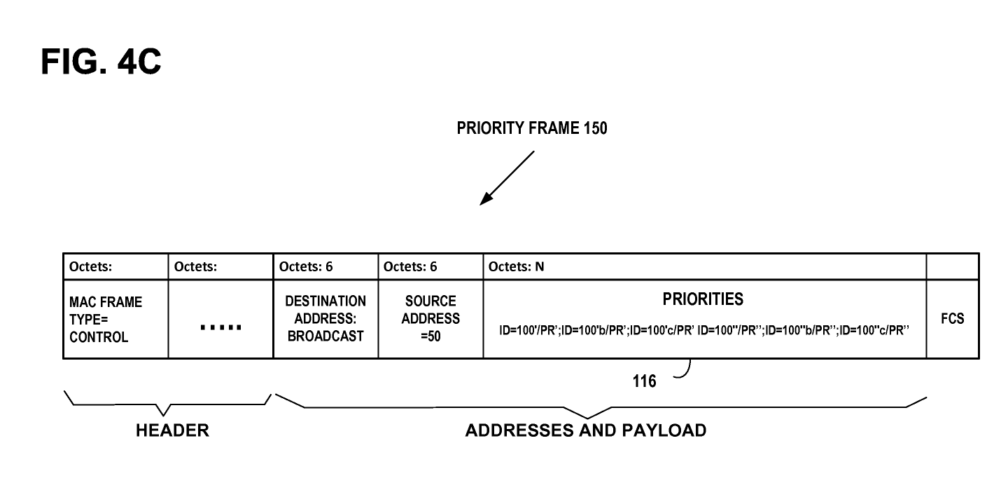

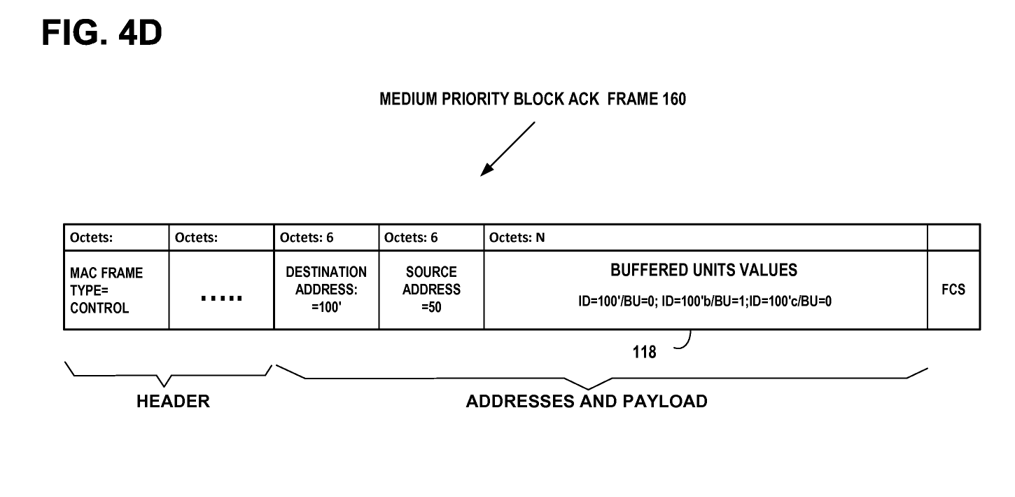

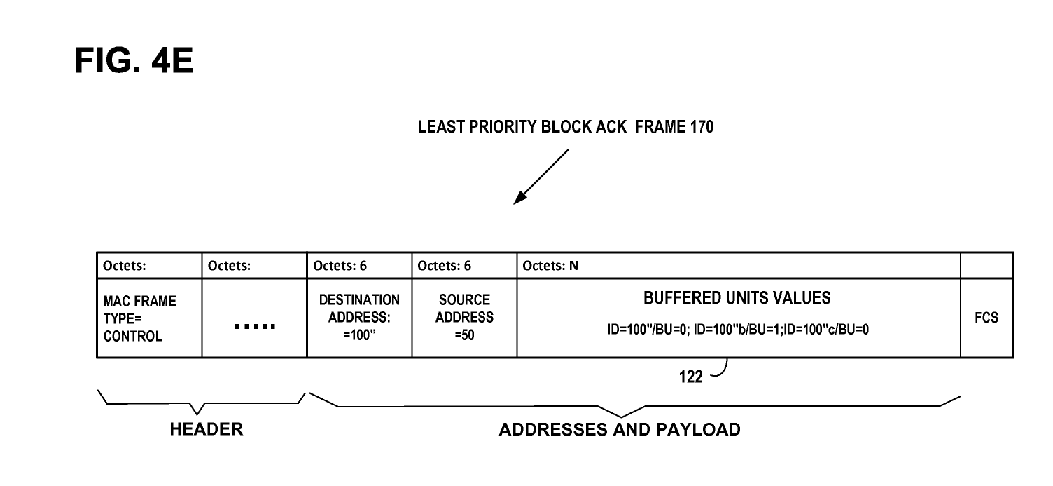

During the association and authentication phase, information indicating the wake-up period WP 106 and the device type DT 108 of the WLAN client device 100 (for example, whether the client is a long or short sleeper and the maximum buffer size MX of its client buffer) may be transmitted to the WLAN access point device 50 during the association and authentication phase, using Association Request 104 and Association Response frames. FIG. 4 is an example frame structure of the association request packet, according to an example embodiment of the invention.

The WLAN client device 100 has a wake-up period WP 106 and a device type DT 108, which information is sent to the WLAN access point device 50 in the Association Request frame 104. The device type DT includes the Maximum buffer size MX in the WLAN client device. The second WLAN client device 100′ has a wake-up period WP′ and a device type DT', which information may be separately sent to the WLAN access point device 50 in another Association Request 104. The WLAN access point device 50 accumulates in a client data table 55 the wake-up period WP 106, the device type DT 108, and the maximum buffer size MX for each of the WLAN client devices 100 and 100′ in its infrastructure network 70. Example data accumulated in the client data table 55 would appear as shown in Table 1:

TABLE 1
Client data table 55 in Access Point:

| | Client Device | | | | | | |
|---|---|---|---|---|---|---|---|
| | 100 | 100b | 100c | 100′ | 100′b | 100″ | 100″b |
| Wake-up Period | WP | WP | WP | WP′ | WP′ | WP″ | WP″ |
| Maximum buffer | MX | MX | MX | MX′ | MX′ | MX″ | MX″ |
| size | | | | | | | |

In an example embodiment of the invention, the following are four example device types of WLAN client devices possible in IEEE 802.11ah networks:
Short sleeper periodic WLAN client device: WLAN client devices concerned with health monitoring data transmitting short periodic packets for each patient;
Short sleeper aperiodic WLAN client device: WLAN client devices used for industry automation and cellular offloading;
Long sleeper periodic WLAN client device: WLAN client devices like the gas and meter sensors transmitting data in periodic but long intervals, like 4 hours;
Long sleeper aperiodic WLAN client device: WLAN client devices with event-based data transmissions;

FIG. 1A is an example network diagram of the wireless network of FIG. 1, with a WLAN client device 100 that is waking up from a doze or sleep state, sending a power save poll packet 110 to a WLAN access point device 50 over a WLAN link 101 in a wireless infrastructure BSS 70. The power save poll packet 110 includes the Buffered Data Quantity Threshold TH field 112, the Critical Data CD field 114, and the quality of service (QoS) field 115, according to an example embodiment of the invention. FIG. 4A is an example frame structure of the power save poll packet, according to an example embodiment of the invention. The WLAN client device 100 may send the power save poll packet 110 or trigger frame to the WLAN access point device 50 to retrieve any queued data at the WLAN access point device 50 and also transmit any data queued from the WLAN client device 100 to the WLAN access point device 50. The WLAN client device 100 may be a sensor device or a node in a smart grid. Both the WLAN client device 100 and the access point device 50 may be devices operating according to the IEEE 802.11ah communications protocol. The access point device 50 may be connected to a wireline infrastructure 60. The second WLAN client device 100′ has a Buffered Data Quantity Threshold TH′ field 112, the Critical Data CD′ field 114, and the quality of service (QoS) field 115, which information may be separately sent to the WLAN access point device 50 in another power save poll packet 110. The third WLAN client device 100″ has a Buffered Data Quantity Threshold TH″ field 112, the Critical Data CD″ field 114 and the quality of service (QoS) field 115, which information may be separately sent to the WLAN access point device 50 in another power save poll packet 110.

The WLAN access point device 50 accumulates in the client data table 55 the Buffered Data Quantity Threshold TH field 112, the Critical Data CD field 114 and the quality of service (QoS) field 115, along with the wake-up period WP 106 and the device type DT 108 for each of the WLAN client devices 100, 100′, and 100″ in its infrastructure network 70.

In an example embodiment of the invention, the Buffered Data Quantity Threshold TH 112 indicates a threshold (in Kbytes expressed as an exponent of 2) of buffered data, above which the WLAN client device 100 wishes to receive a notice of the buffered data. The Critical Data CD 114 indicates if the WLAN client device 100 is waiting for time-critical or periodic information. The quality of service (QoS) field 115 indicates a threshold quality of service (QoS) for the buffered data, above which the WLAN client device 100 wishes to receive a notice of the buffered data. The Buffered Data Quantity Threshold TH 112, the Critical Data CD 114, and quality of service (QoS) field 115 may be utilized by the WLAN access point device 50 in defining priorities among the WLAN client devices 100, 100′, and 100″ in the infrastructure network 70.

Example data accumulated in the client data table 55 of the access point 50 would appear as shown in Table 2:

TABLE 2
Client data table 55 in Access Point:

| | Client Device | | | | | | |
|---|---|---|---|---|---|---|---|
| | 100 | 100b | 100c | 100′ | 100′b | 100″ | 100″b |
| Wake-up Period | WP | WP | WP | WP′ | WP′ | WP″ | WP″ |
| Maximum buffer | MX | MX | MX | MX′ | MX′ | MX″ | MX″ |
| size | | | | | | | |
| Buffered Data | TH | TH | TH | TH′ | TH′ | TH″ | TH″ |
| Quantity Threshold | | | | | | | |
| Critical Data CD | CD | CD | CD | CD | CD | CD | CD |
| Quality of Service | QoS | QoS | QoS | QoS′ | QoS′ | QoS″ | QoS″ |
| (QoS) | | | | | | | |

FIG. 1B shows the example network diagram of FIG. 1A, wherein the WLAN access point device 50 computes the WLAN priorities and sets the values of buffered units BU for each WLAN client device. The WLAN access point 50 transmits an immediate acknowledgement packet 120 to the WLAN client device 100 having the highest priority, with a value of the buffered units BU 125 indicating whether the WLAN access point device 50 has buffered data for the WLAN client device 100, according to an example embodiment of the invention. FIG. 4B is an example frame structure of the immediate acknowledgement packet 120, according to an example embodiment of the invention.

In an example embodiment of the invention, the WLAN client priorities are computed as follows:

Highest priority: Critical Data field set to 1 and buffered data>Buffered Data Quantity Threshold or buffered data<Buffered Data Quantity Threshold;

Medium priority: Critical Data field set to 0 and buffered data>Buffered Data Quantity Threshold but buffered data<Maximum buffer size per WLAN client device;

Least priority: Critical Data field set to 0 and buffered data<Buffered Data Quantity Threshold;

For the highest priority WLAN client devices, the WLAN access point device sends an immediate ACK frame 120.

An ACK frame 120 is sent by the WLAN access point (AP) device 50 in response to the power save poll (PS-Poll) message 110, trigger frame, or other type message. The ACK frame 120 may include a buffer units (BU) field 125 indicating whether there is data buffered in the AP 50 for the WLAN client device 100. If the number of bytes of buffered data in the AP 50 exceeds the Buffered Data Quantity Threshold 112 indicated in the power save poll (PS-Poll) message 110, for example, the AP 50 will set the value of the buffer units field 125 to BU=1 in the ACK frame 120 indicating that there is buffered data present in the AP 50.

Example data accumulated in the client data table 55 of the access point 50 and the computed priorities and buffer unit BU values would appear as shown in Table 3:

TABLE 3
Client Data Table 55 in Access Point:

| | Client Device | | | | | | |
|---|---|---|---|---|---|---|---|
| | 100 | 100b | 100c | 100′ | 100′b | 100″ | 100″b |
| Wake-up Period | WP | WP | WP | WP′ | WP′ | WP″ | WP″ |
| Maximum buffer | MX | MX | MX | MX′ | MX′ | MX″ | MX″ |
| size | | | | | | | |
| Buffered Data | TH | TH | TH | TH′ | TH′ | TH″ | TH″ |
| Quantity Threshold | | | | | | | |
| Critical Data CD | CD | CD | CD | CD | CD | CD | CD |
| Quality of Service | QoS | QoS | QoS | QoS′ | QoS′ | QoS″ | QoS″ |
| (QoS) | | | | | | | |
| WLAN client | PR | PR | PR | PR′ | PR′ | PR″ | PR″ |
| priorities | | | | | | | |
| Buffer Unit BU | BU | BU | BU | BU′ | BU′ | BU″ | BU″ |
| values | | | | | | | |

For the highest priority WLAN client devices 100, 100b, 100c decided upon the critical data and the quality of service, the WLAN access point device 50 will send an immediate ACK 120.

If a WLAN client device 100 receives an immediate ACK, it infers that it is of highest priority and stays awake to receive and decode the information of the buffered data 130 sent in a data frame by the WLAN access point 50 at a later time after receipt of the ACK frame 120.

If the number of bytes of buffered data in the AP 50 is less than the Buffered Data Quantity Threshold 112 indicated in the power save poll (PS-Poll) message 110, for example, the AP 50 will set the value of the buffer units field 125 to BU=0 in the ACK frame 120 indicating that there is no buffered data present in the AP 50.

Even if there is actually some data buffered in the AP 50 for the WLAN client device 100, if it is less than the Buffered Data Quantity Threshold 112 indicated in the power save poll (PS-Poll) message 110, then the AP 50 will set the value of the buffer units field 125 to BU=0 in the ACK frame 120. This buffer units field 125 is utilized by the WLAN access point device 50 in defining priorities among the WLAN client devices 100 and 100′.

In an example embodiment of the invention, if the Next Wake-up Period is from a short sleeper (periodic and aperiodic) WLAN client device 100, and if the Maximum buffer size (as indicated by the device type DT) of the WLAN client device 100 is greater than the Buffered data in the AP 50, then the WLAN access point device 50 may disregard the Buffered Data Quantity Threshold 112 for the WLAN client device 100 and the AP 50 will send an ACK message 120 that indicates a buffered units 125 value BU=0. In other words, if the WLAN access point device 50 does not have sufficient buffered data for the short sleeper WLAN client device 100, the WLAN access point device 50 may refrain from downloading data 130 and instead, will wait till the next wake-up period.

In an example embodiment of the invention, if the Next Wake-up Period is from long sleeper (periodic and aperiodic) WLAN client device 100, then based on Buffered Data Quantity Threshold 112 of the WLAN client device 100, the WLAN access point device 50 may set the buffered units 125 value BU value as follows: If the buffered data in the AP 50 is less than the Buffered Data Quantity Threshold 112, then the AP 50 sets the buffered units 125 value BU=0; otherwise the AP 50 sets the buffered units 125 value BU=1.

In an example embodiment of the invention, by default, the WLAN access point device 100 may possess the discretion to set the buffered units 125 value BU bit=1 for buffered data related to changes in the Beacon frame.

The WLAN client device 100 remains in the awake state when the buffered units 125 indicates that there is data buffered for the WLAN client device 100 in the WLAN access point device 50.

If a WLAN client device 100 does not receive an immediate ACK frame 120, it may assume either of the two cases: (i) WLAN client device 100 is of highest priority but its PS-Poll message 110 has not been received correctly at the AP 50; or (ii) WLAN client device 100 is either of medium or least priority.

In case of no immediate ACK frame 120, the WLAN client devices 100′ remain awake to await a Priority Frame 150 from the AP 50. A Priority Frame 150 may be transmitted every, approximately five, PS-Poll messages 110 or in terms of the short beacon frame, for example, the end of every short beacon frame. The acknowledgements may also be transmitted together with the short or long beacon. FIG. 4C is an example frame structure of the priority frame packet 150, according to an example embodiment of the invention. The Priority Frame 150 may inform the waiting WLAN client devices about their priorities 116, based on Critical Data 114 and Buffered Data Quantity Threshold 112 fields for all the awaiting WLAN client devices 100, 100′, 100″, etc.

FIG. 1C shows the example network diagram of FIG. 1A, wherein WLAN access point 50 transmits a priority frame 150 to WLAN client devices 100′, 100′a, and 100′b and the WLAN client devices 100″, 100″a, and 100″b in the network, specifying the priorities of the respective WLAN client devices, according to an example embodiment of the invention.

In case of no immediate ACK 120, the WLAN client devices remain awake for a Priority Frame 150 from the AP 50. A Priority Frame 150 may be transmitted every, approximately five, PS-Poll messages 110 or in terms of the short beacon frame, for example, the end of every short beacon frame. The Priority Frame 150 may inform about the IDs and priorities (based on Critical Data and Buffered Data Quantity Threshold fields) of all the awaiting WLAN client devices.

FIG. 1D shows the example network diagram of FIG. 1A, wherein WLAN access point 50 transmits a medium priority block acknowledgement frame 160 to medium priority WLAN client devices 100′, 100′b, and 100′c in the network, according to an example embodiment of the invention. FIG. 4D is an example frame structure of the medium priority block acknowledgement frame packet 160, according to an example embodiment of the invention.

A medium priority block ACK frame 160 in FIG. 1D is transmitted every, approximately two, Priority Frame periods while a least priority block ACK frame 170 in FIG. 1E is transmitted every, approximately three, Priority Frame periods. The WLAN client devices decode their priority information from the Priority Frame 150 and enter sleep mode until the predefined duration for the next medium priority block ACK frame 160 or least priority block ACK frame 170 from the AP 50. The reference to this predefined duration is with respect to the end of the current Priority Frame 150. Further, if a WLAN client device does not find its ID in the Priority Frame 150, then it may conclude that the WLAN access point device 50 did not receive its PS-Poll message 110. If this WLAN client device is waiting for some Critical Data, it transmits a PS-Poll message 110 again, otherwise goes to sleep until its next Wake-Up Period. Additionally, if a WLAN client device does not receive a Priority Frame 150, it waits for the consecutive scheduled Priority Frame 150. If it still misses the second Priority Frame 150, it concludes that it is experiencing bad channel conditions, like fading or shadowing, between the WLAN access point device 50 and itself, and goes to sleep till its next Wake-Up Period. Otherwise, based on its assigned priority from the Priority Frame 150, it wakes up for either the scheduled medium (or least) Block ACK frame.

FIG. 1E shows the example network diagram of FIG. 1A, wherein WLAN access point 50 transmits a least priority block acknowledgement frame 170 to least priority WLAN client devices 100″, 100″b, and 100″c in the network, according to an example embodiment of the invention. FIG. 4E is an example frame structure of the least priority block acknowledgement frame packet 170, according to an example embodiment of the invention.

A medium priority block ACK frame 160 or least priority block ACK frame 170 provides information about the IDs and BU bits for all the awaiting medium (least) priority PS-Poll messages. Please note that the BU bits are decided by the WLAN access point device based on type of WLAN client device and its Wake-up Period parameters as discussed earlier. The information in the Priority Frame allows the awaiting WLAN client devices to sleep till the next block ACK and avoid waking up indefinitely for a lost immediate ACK from the AP. Considering two different wake up durations for medium and least priority WLAN client devices allows the WLAN access point device with reduced data processing for medium and least priority WLAN client devices. In the best case with all least priority WLAN client devices, overhead from immediate ACK (prior art) can be significantly minimized by using least priority block ACK frames.

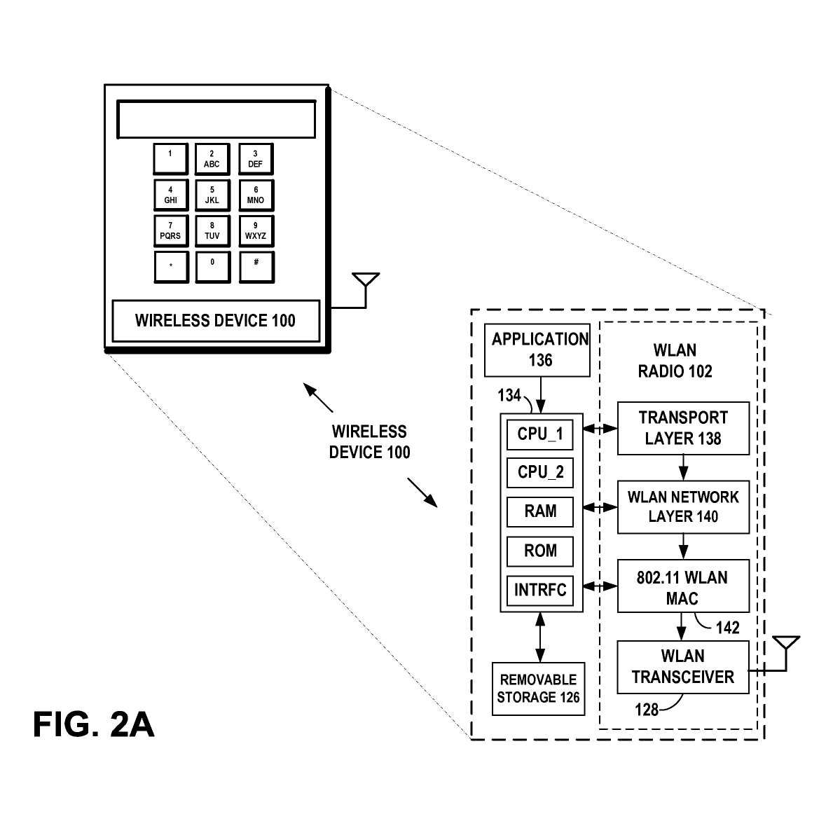

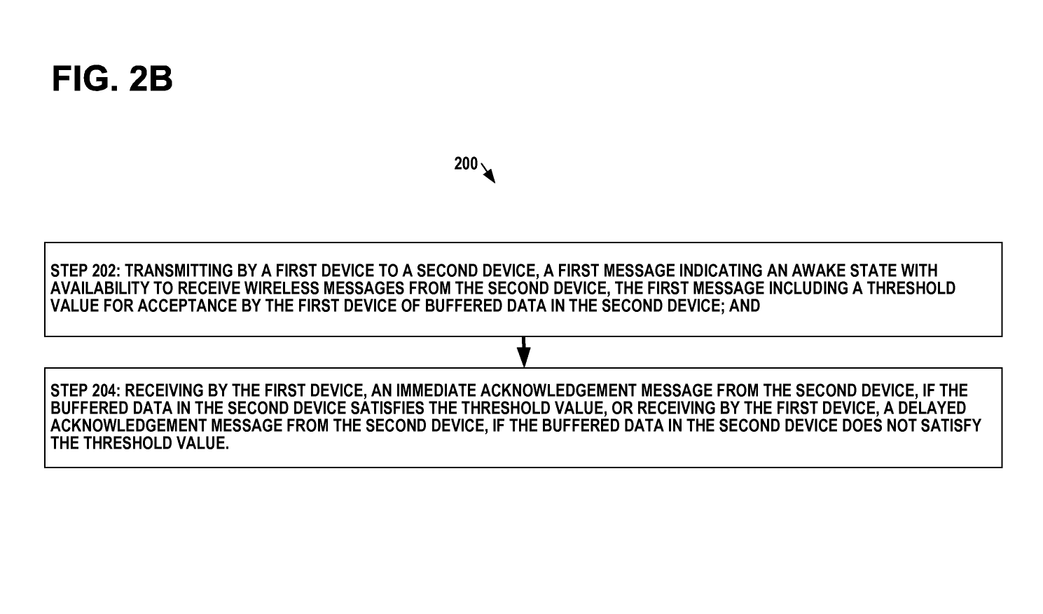

FIG. 2A is an example functional block diagram, illustrating an example WLAN client device 100, according to an example embodiment of the invention. The example WLAN client device 100 may include a processor 134 that may include a dual or multi-core central processing unit CPU_1 and CPU_2, a RAM memory, a ROM memory, and an interface for a keypad, display, and other input/output devices. The example WLAN client device 100 may include a protocol stack, including the transceiver 128 and IEEE 802.11 MAC 142, which may be based, for example, on the IEEE 802.11 ah WLAN standard. The protocol stack may also include a network layer 140, a transport layer 138, and an application program 136.

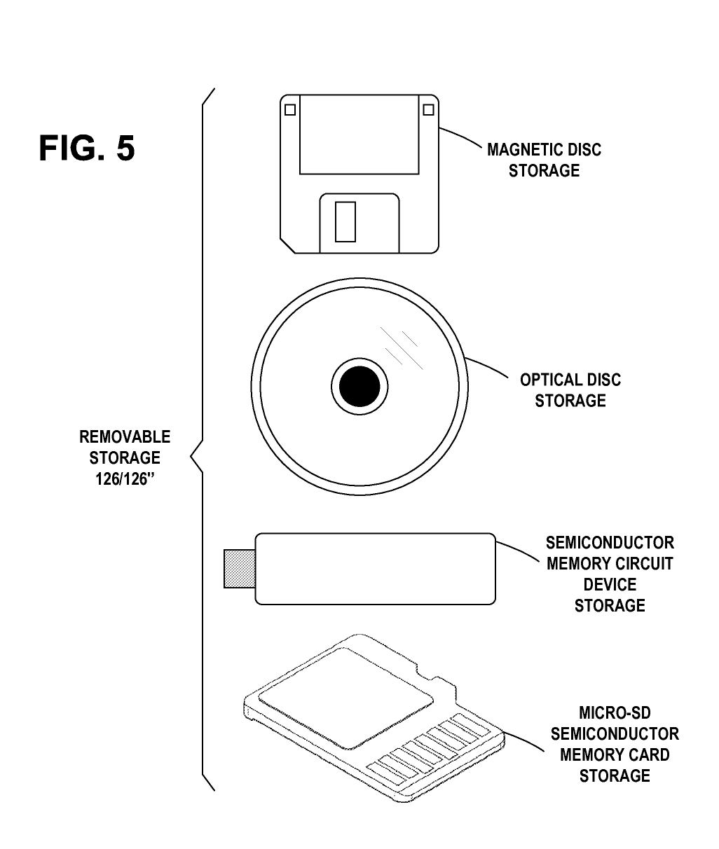

In an example embodiment, the interface circuits in FIG. 2A may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 5, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 2B is an example flow diagram of operational steps in the WLAN client device 100 of FIG. 2A, wherein the WLAN client device 100 transmits to WLAN access point device 50, a first message 110 indicating an awake state with availability to receive wireless messages from the WLAN access point device 50, according to an example embodiment of the invention.

The steps of the flow diagram 200 of FIG. 2B may represent computer code instructions stored in the RAM and/or ROM memory of the WLAN client device 100, which when executed by the central processing units (CPU), carry out the functions of an example embodiment of the invention. The steps may be carried out in another order than shown and individual steps may be combined or separated into component steps.

Step 202: transmitting by a first device to a second device, a first message indicating an awake state with availability to receive wireless messages from the second device, the first message including a threshold value for acceptance by the first device of buffered data in the second device; and

Step 204: receiving by the first device, an immediate acknowledgement message from the second device, if the buffered data in the second device satisfies the threshold value, or receiving by the first device, a delayed acknowledgement message from the second device, if the buffered data in the second device does not satisfy the threshold value.

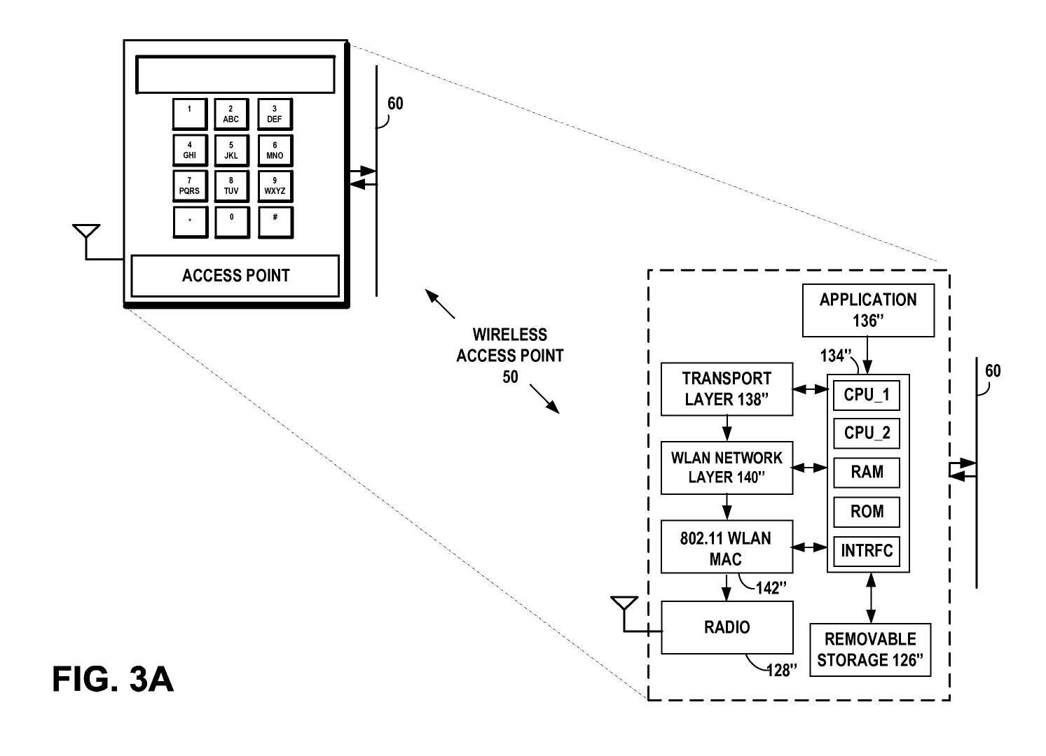

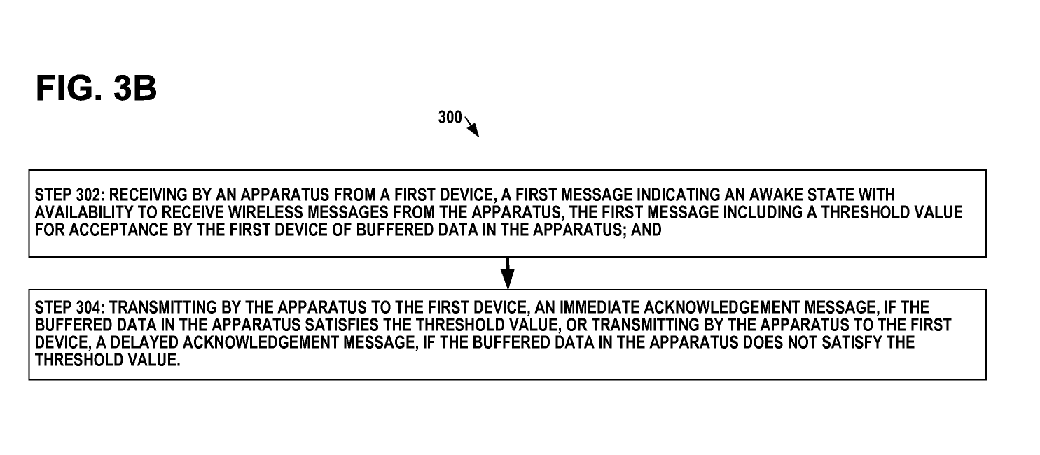

FIG. 3A is an example functional block diagram, illustrating an example WLAN access point device 50, according to an example embodiment of the invention. The example WLAN access point device 50 may include a processor 134″ that may include a dual or multi-core central processing unit CPU_1 and CPU_2, a RAM memory, a ROM memory, and an interface for a keypad, display, and other input/output devices. The example WLAN access point device 50 may include a protocol stack, including the transceiver 128″ and IEEE 802.11ah MAC 142″, which may be based, for example, on the IEEE 802.11ah WLAN standard. The protocol stack may also include a network layer 140″, a transport layer 138″, and an application program 136″.

In an example embodiment, the interface circuits in FIG. 3A may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126″, as shown in FIG. 5, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 3B is an example flow diagram of operational steps in the WLAN access point device of FIG. 3A, wherein the WLAN access point device receives a first message 110 from the WLAN client device 100, indicating an awake state of the WLAN client device 100 with availability to receive wireless messages from the WLAN access point device 50, according to an example embodiment of the invention.

The steps of the flow diagram 300 of FIG. 3B may represent computer code instructions stored in the RAM and/or ROM memory, which when executed by the central processing units (CPU), carry out the functions of an example embodiment of the invention. The steps may be carried out in another order than shown and individual steps may be combined or separated into component steps.

Step 302: receiving by an apparatus from a first device, a first message indicating an awake state with availability to receive wireless messages from the apparatus, the first message including a threshold value for acceptance by the first device of buffered data in the apparatus; and

Step 304: transmitting by the apparatus to the first device, an immediate acknowledgement message, if the buffered data in the apparatus satisfies the threshold value, or transmitting by the apparatus to the first device, a delayed acknowledgement message, if the buffered data in the apparatus does not satisfy the threshold value.

FIG. 4 is an example frame structure of the association request packet 104, according to an example embodiment of the invention. An example frame structure having the general format of the IEEE 802.11 MAC frame, is shown of an association request packet frame 104 transmitted from the WLAN client device 100 to the WLAN access point 50, according to an example embodiment of the invention. The payload portion of the packet frame 104 may include the wake up period 106 and the maximum buffer size 108 as characterizing a data type.

FIG. 4A is an example frame structure of the power save poll packet 110, according to an example embodiment of the invention. An example frame structure having the general format of the IEEE 802.11 MAC frame, is shown of a power save poll packet frame 110 transmitted from the WLAN client device 100 to the WLAN access point 50, according to an example embodiment of the invention. The payload portion of the packet frame 110 may include the buffered data quantity threshold 112, the critical data 114 as characterizing a data type, and the quality of service (QoS) field 115 that indicates a threshold quality of service (QoS) for the buffered data, above which the WLAN client device 100 wishes to receive a notice of the buffered data.

FIG. 4B is an example frame structure of the immediate acknowledgement packet 120, according to an example embodiment of the invention. An example frame structure having the general format of the IEEE 802.11 MAC frame, is shown of an immediate acknowledgement packet frame 120 transmitted from the WLAN access point device 50 to the WLAN client device 100, according to an example embodiment of the invention. The payload portion of the packet frame 120 may include the buffered units value BU 125.

FIG. 4C is an example frame structure of the priority frame packet 150, according to an example embodiment of the invention. An example frame structure having the general format of the IEEE 802.11 MAC frame, is shown of a priority packet frame 150 transmitted from the WLAN access point device 50 to the WLAN client devices 100′, 100′b, and 100′c and the WLAN client devices 100″, 100″b, and 100″c, according to an example embodiment of the invention. The payload portion of the packet frame 150 may include the priorities 116 of the WLAN client devices computed by the WLAN access point 50. Example priorities PR 116 corresponding to the IDs of the WLAN client devices, as shown in the FIG. 4C, are ID=100′/PR′; ID=100′b/PR′; ID=100′c/PR′; ID=100″/PR″; ID=100″b/PR″; ID=100″c/PR″.

FIG. 4D is an example frame structure of the medium priority block acknowledgement frame packet 160, according to an example embodiment of the invention. An example frame structure having the general format of the IEEE 802.11 MAC frame, is shown of a packet frame 160 transmitted from the WLAN access point device 50 to the medium priority WLAN client devices 100′, 100′b, and 100′c, according to an example embodiment of the invention. The payload portion of the packet frame 160 may include the buffered units value BU 118 of the medium priority WLAN client devices 100′, 100′b, and 100′c computed by the WLAN access point 50. Example buffered units value BU 118 corresponding to the IDs of the WLAN client devices, as shown in the FIG. 4D, are ID=100′/BU=0; ID=100′b/BU=1; ID=100′c/BU=0.

FIG. 4E is an example frame structure of the least priority block acknowledgement frame packet 170, according to an example embodiment of the invention. An example frame structure having the general format of the IEEE 802.11 MAC frame, is shown of a packet frame 170 transmitted from the WLAN access point device 50 to the least priority WLAN client devices 100″, 100″b, and 100″c, according to an example embodiment of the invention. The payload portion of the packet frame 170 may include the buffered units value BU of the least priority WLAN client devices 100″, 100″b, and 100″c computed by the WLAN access point 50. Example buffered units value BU 122 corresponding to the IDs of the WLAN client devices, as shown in the FIG. 4E, are ID=100″/BU=0; ID=100″b/BU=1; ID=100″c/BU=0.

FIG. 5 illustrates an example embodiment of the invention, wherein examples of removable storage media 126 and 126″ are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
transmitting by a first device to a second device, a first message indicating an awake state with availability to receive wireless messages from the second device, the first message including a threshold value for acceptance by the first device of buffered data in the second device; and
receiving by the first device, an immediate acknowledgement message from the second device, if the buffered data in the second device satisfies the threshold value, or receiving by the first device, a delayed acknowledgement message from the second device, if the buffered data in the second device does not satisfy the threshold value.

2. The method of claim 1, further comprising:
entering a sleep state by the first device when an immediate acknowledgement message is not received from the second device in response to the first message; and
waiting for a predetermined duration before resuming an awake state to receive the delayed acknowledgement message from the second device.

3. The method of claim 1, further comprising:
receiving by the first device, a priority frame message from the second device, including a priority indication for the first device, based on the threshold value for acceptance by the first device of buffered data in the second device; and
entering a sleep state for a predetermined duration before resuming the awake state to receive the delayed acknowledgement message.

4. The method of claim 1, further comprising:
wherein the delayed acknowledgement message includes a buffered units indication indicating whether there is data buffered in the second device for the first device and a duration field to a next service period, indicating a duration to initiation of a downlink data phase from the second device to the first device; and
entering a sleep state until the duration to the next service period in order to receive the buffered data if the buffered data units indication indicates that there is buffered data or entering a sleep state for a predetermined duration if the buffered data units indication indicates that there is no buffered data.

5. The method of claim 1, further comprising:
wherein the threshold value is at least one of a critical data value indicating whether the first wireless device is waiting for time-critical data, a buffered data quantity threshold value, and a quality of service threshold value for the buffered data.

6. An apparatus, comprising:
at least one processor;
at least one memory including computer program code;
the at least one memory and the computer program code configured to, with the at least one processor, cause the apparatus at least to:
transmit to a second device, a first message indicating an awake state with availability to receive wireless messages from the second device, the first message including a threshold value for acceptance by the apparatus of buffered data in the second device; and
receive an immediate acknowledgement message from the second device, if the buffered data in the second device satisfies the threshold value, or receive a delayed acknowledgement message from the second device, if the buffered data in the second device does not satisfy the threshold value.

7. The apparatus of claim 6, further comprising:
the at least one memory and the computer program code configured to, with the at least one processor, cause the apparatus at least to:
enter a sleep state when an immediate acknowledgement message is not received from the second device in response to the first message; and
wait for a predetermined duration before resuming an awake state to receive the delayed acknowledgement message from the second device.

8. The apparatus of claim 6, further comprising:
the at least one memory and the computer program code configured to, with the at least one processor, cause the apparatus at least to:
receive a priority frame message from the second device, including a priority indication for the apparatus, based on the threshold value for acceptance by the apparatus of buffered data in the second device; and
enter a sleep state for a predetermined duration before resuming the awake state to receive the delayed acknowledgement message.

9. The apparatus of claim 6, further comprising:
wherein the delayed acknowledgement message includes a buffered units indication indicating whether there is data buffered in the second device for the apparatus and a duration field to a next service period, indicating a duration to initiation of a downlink data phase from the second device to the first device; and
the at least one memory and the computer program code configured to, with the at least one processor, cause the apparatus at least to:
enter a sleep state until the duration to the next service period in order to receive the buffered data if the buffered data units indication indicates that there is buffered data or entering a sleep state for a predetermined duration if the buffered data units indication indicates that there is no buffered data.

10. The apparatus of claim 6, further comprising:
wherein the threshold value is at least one of a critical data value indicating whether the first device is waiting for time-critical data, a buffered data quantity threshold value, and a quality of service threshold value for the buffered data.

11. A computer program product comprising computer executable program code recorded on a computer readable, non-transitory storage medium, the computer executable program code comprising:
code for transmitting to a second device, a first message indicating an awake state with availability to receive wireless messages from the second device, the first message including a threshold value for acceptance of buffered data in the second device; and
code for receiving an immediate acknowledgement message from the second device, if the buffered data in the second device satisfies the threshold value, or receiving a delayed acknowledgement message from the second device, if the buffered data in the second device does not satisfy the threshold value.

12. A method, comprising:
receiving by an apparatus from a first device, a first message indicating an awake state with availability to receive wireless messages from the apparatus, the first message including a threshold value for acceptance by the first device of buffered data in the apparatus; and
transmitting by the apparatus to the first device, an immediate acknowledgement message, if the buffered data in the apparatus satisfies the threshold value, or transmitting by the apparatus to the first device, a delayed acknowledgement message, if the buffered data in the apparatus does not satisfy the threshold value.

13. The method of claim 12, further comprising:
setting by the apparatus, a buffered units indication in the immediate acknowledgement message, indicating whether there is data buffered in the apparatus for the first device.

14. The method of claim 12, further comprising:
transmitting by the apparatus to the first device, a priority frame message, including a priority indication for the first device, based on the threshold value for acceptance by the first device of buffered data in the apparatus.

15. The method of claim 12, further comprising:
setting by the apparatus, a buffered units indication in the delayed acknowledgement message, indicating whether there is data buffered in the apparatus for the first device.

16. The method of claim 12, further comprising:
wherein the threshold value is at least one of a critical data value indicating whether the first device is waiting for time-critical data, a buffered data quantity threshold value, and a quality of service threshold value for the buffered data.

17. An apparatus, comprising:
at least one processor;
at least one memory including computer program code;
the at least one memory and the computer program code configured to, with the at least one processor, cause the apparatus at least to:
receive from a first device, a first message indicating an awake state with availability to receive wireless messages from the apparatus, the first message including a threshold value for acceptance by the first device of buffered data in the apparatus; and
transmit by the apparatus to the first device, an immediate acknowledgement message, if the buffered data in the apparatus satisfies the threshold value or transmit by the apparatus to the first device, a delayed acknowledgement message, if the buffered data in the apparatus does not satisfy the threshold value.

18. The apparatus of claim 17, further comprising:
the at least one memory and the computer program code configured to, with the at least one processor, cause the apparatus at least to:
set in the immediate acknowledgement message a buffered units indication, which is based on the device type, wake-up period, and buffered data threshold indication from the first device; the buffered units indication informing whether there is data buffered in the apparatus for the first device, wherein the first device is of highest priority,

19. The apparatus of claim 17, further comprising:
the at least one memory and the computer program code configured to, with the at least one processor, cause the apparatus at least to:
transmit to the first device, a priority frame message, including a priority indication for the first device, based on the threshold value for acceptance by the first device of buffered data in the apparatus.

20. The apparatus of claim 17, further comprising:
set a buffered units indication in the delayed acknowledgement message, indicating whether there is data buffered in the apparatus for the first device and a duration field to a next service period, indicating a duration to initiation of a downlink data phase from the apparatus to the first device.

21. The apparatus of claim 17, further comprising:
wherein the threshold value is at least one of a critical data value indicating whether the first device is waiting for time-critical data, a buffered data quantity threshold value, and a quality of service threshold value for the buffered data.

22. A computer program product comprising computer executable program code recorded on a computer readable, non-transitory storage medium, the computer executable program code comprising:
code for receiving by an apparatus from a first device, a first message indicating an awake state with availability to receive wireless messages from the apparatus, the first message including a threshold value for acceptance by the first device of buffered data in the apparatus; and
code for transmitting by the apparatus to the first device, an immediate acknowledgement message, if the buffered data in the apparatus satisfies the threshold value, or transmitting by the apparatus to the first device, a delayed acknowledgement message, if the buffered data in the apparatus does not satisfy the threshold value.
